(19) United States
(12) Patent Application Publication
(10) Pub. No.: US 2004/0187007 A1
(43) Pub. Date: Sep. 23, 2004

(54) Electronic stamp for multimedia messages

(75) Inventors: Paul Vincent, Tournefeuille (FR); Gwenael Lebodic, Puteaux (FR)

Correspondence Address: SUGHRUE MION, PLLC, Suite 800, 2100 Pennsylvania Avenue, N.W,, Washington, DC, 20037-3213, US

(73) Assignee: ALCATEL

(21) Appl. No.: 10/800,670

(22) Filed: Mar. 16, 2004

(30) Foreign Application Priority Data
Mar. 18, 2003 (FR) 03 03 270

(51) Int. Cl. H04L 9/00; H04J 3/24

(52) U.S. Cl. 713/176; 713/160

(57) ABSTRACT

A Multimedia Messaging Service system sends messages in a multimedia messaging environment comprising a multimedia message service center. The system comprises an electronic stamp provider. A stamp is associated with a Multimedia Messaging Service message to be sent by the system and the service center verifies the validity of the stamp.

### CROSS-REFERENCE TO RELATED APPLICATIONS

This application is based on French Patent Application No. 03 03 270 filed Mar. 18, 2003, the disclosure of which is hereby incorporated by reference thereto in its entirety, and the priority of which is hereby claimed under 35 U.S.C. §119.

### BACKGROUND OF THE INVENTION

1. Field of the Invention

The field of the present invention is that of multimedia messages sent and/or received by mobile radio terminals such as mobile telephones.

2. Description of the Prior Art

The expansion of the Multimedia Messaging Service (MMS) follows on from the huge success of the Short Message Service (SMS) and Enhanced Message Service (EMS) in the field of mobile radio. Multimedia message services expand this type of message service by offering the facility to include more and more multimedia data, such as pictures, sound, video sequences, etc. Exchange of MMS messages may be supported by second and third generation radio networks, for example the General Packet Radio Service (GPRS) and the Universal Mobile Telecommunication System (UMTS). In defining the structure and the mode of exchanging MMS messages, multimedia message services also take into account the constraints of interworking with electronic mail services using the Internet. A mobile radio terminal designed to support a multimedia message service and to operate over a second or third generation network is therefore able to exchange multimedia messages with terminals connected to the Internet or to other types of fixed or wireless network.

FIG. 1 shows diagrammatically the network architecture of a multimedia message service.

A multimedia message service is organized to cover a plurality of network elements in order to be able to assure interworking with existing message services such as SMS and EMS and fixed message services such as electronic mail via the Internet. The MMS architecture requires a network infrastructure able to transport, adapt and store MMS messages and software elements for composing, sending and receiving MMS messages, both in the mobile terminal and on the network.

Thus as MMS Environment (MMSE) is defined in a given mobile radio network and includes a set of network elements under the control of a Multimedia Messaging Service Provider (MMS provider) providing access to multimedia message services in the context of a user contract with said network.

The keystone of the MMS network architecture is the relay server shown in FIG. 1 and usually referred to as an MMS center (MMSC). An MMSC is associated with a given MMSE. The MMSC relay is responsible for transporting MMS messages in said environment and to other MMSC' attached to other MMSE' or to other messaging servers, and the MMSC server is responsible for storing MMS messages pending their delivery to a terminal attached to the MMSE. The MMSC is also responsible for adapting the content of MMS messages, for maintaining user registers, and for the interface with systems for billing and applying services offered to users.

A mobile radio terminal (ME) adapted to exchange MMS messages contains software known as the MMS User Agent (MMS-UA). This MMS-UA software is used to compose, present, send and receive MMS messages. Each MMS-UA sending and receiving an MMS message is attached to a respective MMSE corresponding to the network subscription domain of the sender and receiver terminal, the sender and receiver environments possibly being one and the same. An MMS-UA communicates with the MMSC server of its MMSE via a dedicated interface MM1 of said server.

The various elements of the MMSE communicate with each other via standard interfaces. Each interface enables certain operations, such as submission, recovery and transfer of an MMS message, and each operation is associated with a series of parameters known as information elements. A plurality of these interfaces have been standardized in the specifications of the WAP Forum (and have now been adopted by the Open Mobile Alliance (OMA) and the 3GPP), while others constitute proprietary solutions dependent on implementations adapted by MMSC manufacturers.

The MM1 interface is dedicated to communication between the MMSC and the MMS-UA software in the terminal (ME).

The MM2 interface connects the server to the MMS relay in the MMSC.

The MM3 interface connects the MMSC to external servers such as electronic mail servers and Short Message Service (SMS) centers.

The interface MM4 is dedicated to communication between two MMSC. This interface is used to exchange MMS messages between different MMSE.

The MMSC uses the interface MM5 to request location information contained in a Home Location Register (HLR). This enables the MMSC to transfer a message to another domain, for example.

The MMSC uses the interface MM6 to interrogate a database relating to users of the MMSE, for example to collect presence information.

The interface MM7 is dedicated to communication between the MMSC and a Value Added Service Provider (VASP). A VAS application uses this interface to request a service from the MMSC, for example to deliver a message, and to receive MMS-UA messages from mobile terminals.

The interface MM8 is reserved for communication between the MMSC and billing systems.

Only the technical implementation of the interfaces MM1 to MM4 has been standardized by the WAP Forum. At present the other interfaces are proprietary solutions whose specifications remain to be defined with a view to standardization.

FIG. 2 shows diagrammatically the structure of an MMS message. A multimedia message generally takes the form of a multiparty message that may include non-text elements such as pictures, sounds or video sequences to be represented simultaneously when reading the message. A multiparty MMS message is then formatted in accordance with the Multipurpose Internet Mail Extensions (MIME) format extended by binary encoding to transfer the message over the radio link.

Conventionally, an MMS message has a message header (MMS-H) and a message body (MMS-B) that may contain a plurality of body parts (BP) each corresponding to an element of the MMS message such as a sound, a picture, etc. The message body therefore comprises a succession of body parts each containing a header (BP-H) indicating the type of element and its size and data (BP-D) representing the definition of said message element.

The message header (MMS-H) contains information relating to the transportation of the message, such as the identities of the addressee, the sender, addressees of copies, an indication of delivery of the message, and information relating to the message sent, such as the date of sending, the expiry date of the message, the return address, the identification of the message to which it is a reply, the subject matter of the message, etc.

The information in the header is organized into fields which are assigned values defined in the WAP 209 specifications of the WAP Forum.

Conventionally, an MMS message is composed and sent from a mobile terminal (ME) using the MMS-UA software previously described. However, an MMS message can equally be composed and sent from a fixed station such as a personal computer (PC). This kind of message is sent by the PC to a mail server via an Internet connection or to an access provider server via an Internet site, and then to the MMSC via the dedicated MM3 or MM7 interface.

To this end, the way of billing for sending MMS messages is of great importance in assuring the expansion of this type of service.

In the well known SMS, service providers enable users to send SMS messages via a connection to the SMS center of an operator. The operator is paid by the service provider, on the basis of a user agreement or a predefined number of SMS messages.

The situation is more complex in the case of the MMS. If an MMS message is sent from a mobile radio terminal ME connected to an operator, the SMS billing model may be applied, but if an MMS message is sent from a fixed station, for example a PC, via the Internet, another billing model must be defined.

For billing purposes, the MMSC collects information, generates a payment file and sends the data in the file to the billing system via the interface MM8. The MMSC generates the billing information, of the message “submission”, “delivery”, “transfer”, “cancellation” type, as a function of events accomplished, but does not issue an invoice. It is up to the MMS provider to structure billing in accordance with its own policy.

Thus in the case of an MMS message sent from a PC via the Internet, the sender must have an account with a particular service provider (VAS), purely for billing purposes. This constraint puts a burden on surfers and is tending to slow the expansion of MMS communication from the Internet to the world of mobile terminals.

The present invention aims to remove this drawback by proposing a simple billing system that does not represent much of a burden on the user, and in particular that does not require a subscription to any kind of service.

The invention proposes to attach to the MMS message an electronic stamp acquired from an MMS stamp provider. This can be done from a terminal connected to the Internet, in a similar manner to making an on-line purchase, for example.

The electronic stamp of the invention corresponds to an encrypted numerical key whose validity may be verified by the MMSC before delivering the MMS message to the destination mobile terminal.

It is therefore possible to bill senders directly for the cost of MMS messages, without service providers issuing invoices.

### SUMMARY OF THE INVENTION

The present invention provides a multimedia message service consisting in sending a message in a multimedia message service environment comprising a multimedia message service center, wherein a sent Multimedia Messaging Service message includes an electronic stamp whose validity is verified by the multimedia message service center.

An MMS message comprises a header (MMS-H) containing parameters relating to the transportation and the content of the message and a body (MMS-B) containing elements of the message; according to the invention, one parameter in the header is a field corresponding to the stamping of the message.

Depending on the implementation, the value associated with the stamping field of the header is an encrypted numerical value or a binary value indicating the presence of the electronic stamp in the message body.

The present invention also provides a method of sending a multimedia message service message from a sender terminal, the method comprising the steps of:

the sender terminal requesting an electronic stamp from a multimedia message service stamp provider;

assigning the value of the stamp to a parameter of the multimedia message service message sent by the terminal;

a multimedia message service center receiving the multimedia message service message;

the multimedia message service center verifying the validity of the stamp; and

sending the multimedia message service message to the destination terminal if the value of the stamp is validated.

According to one feature of the invention, the method further comprises a step of invalidating the electronic stamp used to send the message.

The invention further consists in a multimedia message service multimedia message system adapted to send a message in a multimedia message service environment comprising a multimedia message service center, which system comprises an electronic stamp provider, a stamp being associated with an MMS message to be sent by said system and said multimedia message service center being adapted to verify the validity of said stamp.

According to one feature of the invention the stamp provider supplies an encrypted numerical value at the request of a terminal and the multimedia message service center holds a corresponding decryption key.

According to one feature of the invention the stamp provider has a register containing a list of stamps already used.

The features and advantages of the present invention will become more clearly apparent on reading the following description, which is given by way of illustrative and nonlimiting example and with reference to the appended drawings.

### BRIEF DESCRIPTION OF THE DRAWINGS

FIG. 1, already described, shows diagrammatically a network architecture enabling the exchange of MMS messages.

FIG. 2, already described, shows diagrammatically the structure of an MMS message.

FIG. 3 shows diagrammatically a system of the invention.

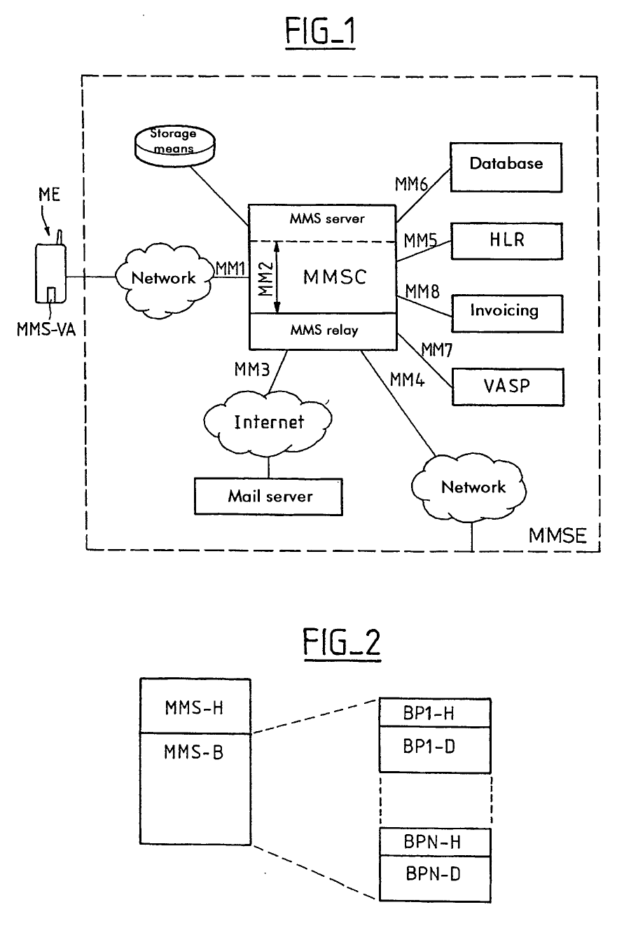

### DETAILED DESCRIPTION OF THE PREFERRED EMBODIMENTS

The present invention proposes a Multimedia Messaging Service (MMS) that may include an element associated with paying for sending said message. The subject matter of the invention finds a particular application in sending an MMS message from a fixed terminal (PC) connected to the Internet, but may also be used when sending an MMS message from a mobile terminal connected to a mobile radio network (GPRS or UMTS), or from any other terminal able to compose and send an MMS message.

According to the invention, the MMS message contains an encapsulated electronic stamp. To this end, the header of the MMS message contains a parameter whose field corresponds to stamping said message. The stamp is a numerical value encrypted by any encryption method known in the art (Digital Signature (DSA), Rivest, Shamir, Adleman (RSA) algorithm, El Gamal method, etc.). The numerical value of the stamp is then incorporated into the MMS message.

Depending on the implementation, the message header MMS-H may contain the encrypted numerical value of the electronic stamp directly in the field corresponding to stamping, or the header may simply indicate by means of a binary value the presence of the electronic stamp in the message body MMS-B, in which case the numerical value of the stamp is contained in a body part BP of the message body MMS-B.

As explained in the introduction, the sending of MMS messages is supported by an MMSE whose keystone is the MMSC. According to the invention, the MMSC is able to verify the validity of an electronic stamp associated with a given MMS message.

Any decryption method known in the art may be used for this operation. For example, if the RSA encryption method is used, the stamp T is encrypted in accordance with the equation:

C=T^{e} mod n

where e is a public key and n=p.q, where p and q are secret large prime numbers.

The MMSC decrypts the stamp as follows:

T=C^{d} mod n

where d is a secret key relating to the exponent e.

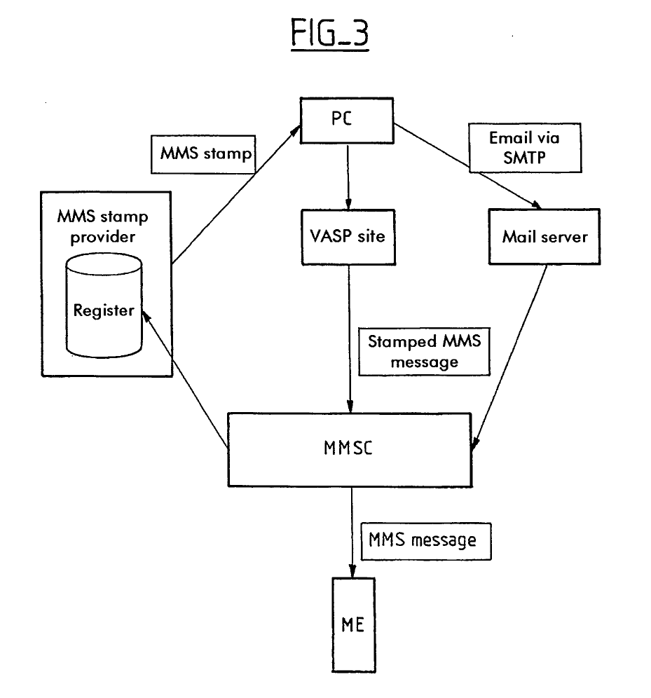

Referring to FIG. 3, the invention relates to a Multimedia Messaging System (MMS) including an electronic stamp provider. The stamp provider is advantageously accessible via the Internet, in the same way as an on-line service site. At the request of a terminal, the stamp provider delivers an electronic stamp in the form of an encrypted numerical value, the service center MMSC holding a corresponding decryption key.

The numerical value of the stamp is preferably a unique identifier which may optionally include the amount of the stamp, which may depend among other things on the size of the message, the message type (advertising, information, personal), and the number of addressees. Where applicable, these parameters are specified when requesting the stamp from the electronic stamp provider.

The stamp provider may be totally independent of the MMSE. Thus different MMSC belonging to different MMSE may hold a decryption key for verifying the validity of the electronic stamp associated with MMS messages sent from a terminal linked to their respective environment. Thus MMS messages sent from terminals that are not attached to an MMS operator of a mobile radio network, as in the case of a PC connected to the Internet, for example, are therefore simply paid for by purchasing an electronic stamp on-line.

Thus the invention proposes a method of sending an MMS message from a sender terminal, for example a PC connected to the Internet. According to this method, the sender terminal submits a request to the stamp provider and the latter supplies a stamp in the form of an encrypted numerical value. The request is accompanied by payment for said stamp, using any on-line purchasing procedure.

The numerical value of said stamp is then associated with a parameter of the MMS message, as previously explained, and the “stamped” MMS message is sent by the sender terminal, for example via a dedicated Internet site or directly in the form of an electronic mail message. The MMS message is then sent to the MMSC of the destination terminal via a Value Added Service Provider (VASP) of the site or via an electronic mail server on the Internet. The MMSC detects the presence of an electronic stamp in said message (a parameter in the header being dedicated to stamping, as previously explained), and decrypts the stamp. If the MMSC finds that the stamp is valid, it transmits the MMS message to the destination terminal.

The method of the invention may further comprise a step of invalidating the stamp that has been used. Invalidation may be carried out after the stamp is used, by the MMSC, which sends the value of the used stamp to the stamp provider, or by the provider itself on supplying said stamp.

The stamp provider therefore comprises a register that contains, for example, the prime numbers and exponent necessary for creating encrypted electronic stamps and a list of stamps already used.

There is claimed:

1. A multimedia message service consisting in sending a message in a multimedia message service environment comprising a multimedia message service center, wherein a sent Multimedia Messaging Service message includes an electronic stamp whose validity is verified by said multimedia message service center.

2. The multimedia message service claimed in claim 1 wherein said Multimedia Messaging Service message comprises a header containing parameters relating to the transportation and the content of said message and a body containing elements of said message and one parameter in said header is a field corresponding to the stamping of said message.

3. The multimedia message service claimed in claim 2 wherein said value associated with said stamping field of said header is an encrypted numerical value.

4. The multimedia message service claimed in claim 2 wherein said value associated with said stamping field in said header is a binary value indicating the presence of said electronic stamp in said message body.

5. The multimedia message service claimed in claim 4 wherein a body part of said message body contains said electronic stamp in the form of an encrypted numerical value.

6. A method of sending a multimedia message service message from a sender terminal, said method comprising the steps of:
the sender terminal requesting an electronic stamp from a multimedia message service stamp provider;
assigning the value of said stamp to a parameter of said multimedia message service message sent by said terminal;
a multimedia message service center receiving said multimedia message service message;
said multimedia message service center verifying the validity of said stamp; and
sending said multimedia message service message to said destination terminal if the value of said stamp is validated.

7. The method claimed in claim 6 further comprising a step of invalidating the electronic stamp used to send said message.

8. The method claimed in claim 7 wherein said step of invalidating said electronic stamp is executed by said multimedia message service center, which sends the value of the used stamp to said MMS stamp provider.

9. The method claimed in claim 7 wherein said step of invalidating said electronic stamp is executed by said MMS stamp provider at the time of supplying said stamp.

10. A multimedia message service multimedia message system adapted to send a message in a multimedia message service environment comprising a multimedia message service center, which system comprises an electronic stamp provider, a stamp being associated with an MMS message to be sent by said system and said multimedia message service center being adapted to verify the validity of said stamp.

11. The multimedia messaging system claimed in claim 10 wherein said stamp provider supplies an encrypted numerical value at the request of a terminal and said multimedia message service center holds a corresponding decryption key.

12. The multimedia messaging system claimed in claim 10 wherein said stamp provider has a register containing a list of stamps already used.

13. The multimedia messaging system claimed in claim 11 wherein said stamp provider has a register containing a list of stamps already used.
